(19) United States
(12) Patent Application Publication
(10) Pub. No.: US 2014/0142985 A1
(43) Pub. Date: May 22, 2014

(54) METHOD AND SYSTEM FOR CONFIDENTIALLY PROVIDING ACCURATE SEXUALLY TRANSMITTED DISEASE INFORMATION

(71) Applicants: Bruce O. Karp, New York, NY (US); Stephen E. Goldstone, New York, NY (US)

(72) Inventors: Bruce O. Karp, New York, NY (US); Stephen E. Goldstone, New York, NY (US)

(21) Appl. No.: 14/085,957

(22) Filed: Nov. 21, 2013

Related U.S. Application Data
(60) Provisional application No. 61/728,864, filed on Nov. 21, 2012.

(51) Int. Cl. G06F 19/00

(52) U.S. Cl. CPC G06F 19/322
USPC 705/3

(57) ABSTRACT

A method for confidentially providing STD information is provided. The method includes receiving at least one first identifying datum uniquely identifying a first person; receiving at least one first STD datum of the first person; receiving at least one second identifying datum uniquely identifying a second person; receiving at least one second STD datum of the second person; providing electronically the first identifying datum and the first STD datum to a requestor authorized by the first person; and providing electronically the second identifying datum and the second STD datum to a further requestor authorized by the second person. A computerized system for confidentially providing STD information is also provided.

This claims the benefit to U.S. Provisional Patent Application No. 61/728,864, filed on Nov. 21, 2012, which is hereby incorporated by reference herein.

### BACKGROUND

In real-life and on-line dating situations, it is difficult to know after meeting someone if they have a sexually-transmitted disease (STD). Often, potential partners do not trust or accept the representations of the other partner.

While a potential partner could directly provide lab data, the possibility exists that the lab data is false or inaccurate. Also, such an interaction can be awkward.

### SUMMARY OF THE INVENTION

The present invention permits people to provide accurate and confidential data concerning one or more STDs.

The data may be laboratory data, which is then verified by an independent service provider. The independent service provider can collect and verify data from several persons, and provide the data as required.

The present invention provides a method for confidentially providing STD information comprising:
receiving at least one first identifying datum uniquely identifying a first person;
receiving at least one first STD datum of the first person;
receiving at least one second identifying datum uniquely identifying a second person;
receiving at least one second STD datum of the second person;
providing electronically the first identifying datum and the first STD datum to a requestor authorized by the first person; and
providing electronically the second identifying datum and the second STD datum to a further requestor authorized by the second person.

The present invention also provides a computerized system for confidentially providing STD information comprising:
a server, a plurality of remote devices capable of communicating with the server, including a first remote device and a second remote device;
the server including a database comprising at least one first identifying datum uniquely identifying a first person; at least one first STD datum of the first person; at least one second identifying datum uniquely identifying a second person; at least one second STD datum of the second person; the server capable of, in response to an electronic request from the first remote device, providing electronically the first identifying datum and the first STD datum to a requestor authorized by the first person, and, in response to a further request from the second remote device, providing electronically the second identifying datum and the second STD datum to a further requestor authorized by the second person.

The present invention also provides a method for operating an STD database comprising:
receiving at least one first identifying datum uniquely identifying a first person;
receiving at least one first STD datum of the first person;
receiving at least one second identifying datum uniquely identifying a second person;
receiving at least one second STD datum of the second person; storing the data above in a database; and
allowing the first identifying datum and the first STD datum to be accessed remotely by a third person given a password by the first person, the first person remaining anonymous.

### BRIEF DESCRIPTION OF THE DRAWINGS

One embodiment of the method and system of the present invention may be further described using the following drawings, in which:

FIG. 1 shows a first GUI of a first remote device with a web page for receiving a request for STD information;

FIG. 2 shows the first GUI of the first remote device with a web page providing the requested STD information; and

FIG. 3 shows a schematic overview of one embodiment of the system of the present invention.

### DETAILED DESCRIPTION OF THE PREFERRED EMBODIMENT

The present invention permits users of a centralized service to provide unique identifiers, such as a photo or biometric information, to the centralized service, together with example their drivers license information or other confirming data. The centralized service can then also receive from the users or directly from laboratories, information on the user's STD status for one or more STDs, such as an HIV lab result, syphilis lab result, etc. The centralized service can confirm the accuracy of the information and provide that information confidentially to potential partners of the users, via a password protected service as described below.

A user of the centralized service is given or created both an ID for use with the service, which can be an alias, and a password. The user can then provide that ID and the password to potential partners to confirm the user's STD status for one or more STDs.

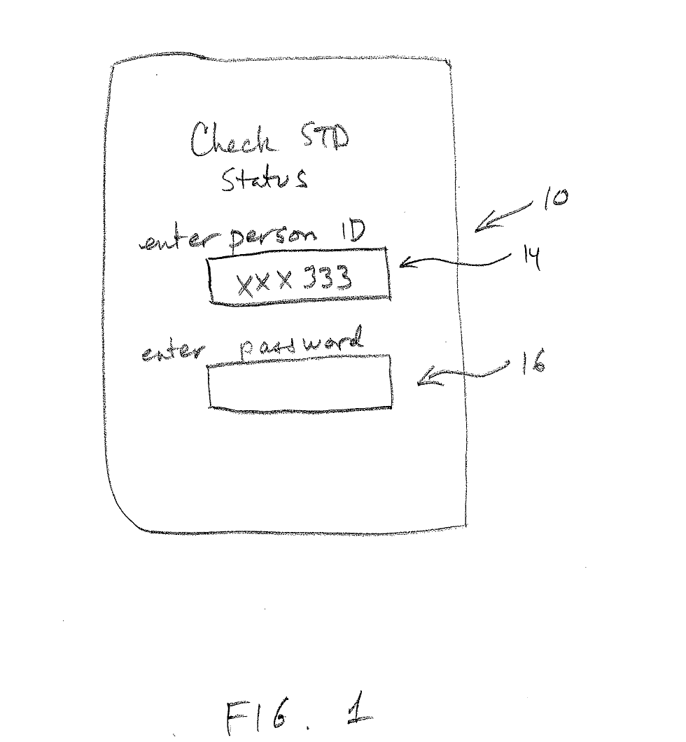

FIG. 1 shows a first graphical user interface (GUI) of a first remote device with a web page or handheld device screen 10 for entering a request to check the STD status of a person, using a password. The first remote device may be any device capable of interacting as a client with a server, for example a home computer, cell phone with web capabilities, or tablet, connected for example via a TCP/IP protocol to a server.

Web page or screen 10 permits a user of the first remote device to enter identifying data 14, for example via a name field, and a password 16 via a password field. The user of the first device can be a potential partner, and the identifying data an alias of the person hoping to provide their STD information accurately to the potential partner. The provider of the STD information can provide the potential partner both the alias and the password.

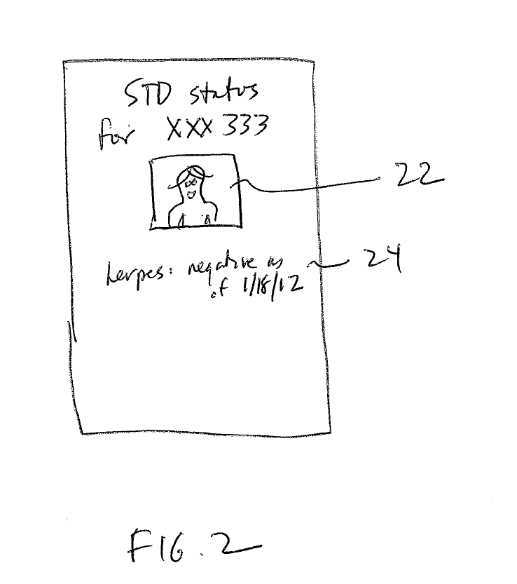

The identifying data 14, here for example an alias XXX333, can be received at a server providing web page or screen 10, and in response to the identifying data, confirmed via the password, the server can provide data concerning a user of the confidential STD service via web page 20, as shown in FIG. 2.

Thus for example a user of the centralized service at a bar can provide the ID XXX333 and the password to a potential partner, and that potential partner can in real time use a cell phone to provide confirm the STD status of the user.

The data provided includes for example a unique identifier 22, for example a photo of the person seeking to provide the STD information, and an STD status 24, which may include a lab result. Thus the potential partner can see that, for example, the person sitting next to him or her (confirmed via the photo) had a negative herpes test on Jan. 18, 2012.

Unique identifier 22 could also be a picture of a tattoo or other physical feature, or a fingerprint or iris pattern of the user of the centralized service, which could be confirmed with the camera of the potential partners cell phone. It could also be answers to specific questions or known numbers or any other way to uniquely identify the provider of the data.

The potential partner can know or have faith that the central service provider has verified the data. The central service provider also could provide or show varying levels of trust or security, for example providing the actual test results, or rating the lab, or even having performed the lab results themselves.

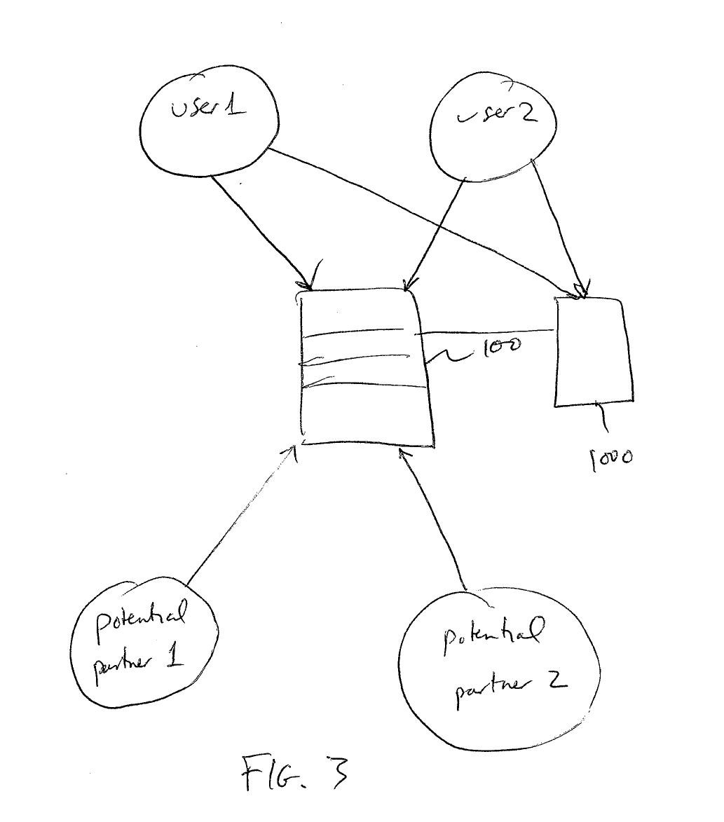

FIG. 3 shows an overview of the system of the present invention with a central server 100 of the central service provider 1000. User 1 and user 2 can for example send lab test results or go to central service provider 1000 to obtain an STD test, and send the unique identifying information as well, for example a copy of a driver's license. The central service provider 1000 verifies that the lab test results are for that actual person.

User 1 and user 2 and other users can create a profile on the central server with their user ID 14 and password 16 and also their actual name, which can remain solely known to the central service provider 1000. The central service provider can then add the unique identifier, for example the driver ID photo, and the test results to the user profile, which is stored in a database accessible as described above via a server 100.

The users can then provide the ID 14 and password, for example to potential partner 1, potential partner 2 and others who can access server 100. The STD result and identifying data can be provided securely, anonymously, if desired, and confidentially.

The users and/or potential partners could be charged a fee for the service.

What is claimed is:

1. A method for confidentially providing STD information comprising:
receiving at least one first identifying datum uniquely identifying a first person;
receiving at least one first STD datum of the first person;
receiving at least one second identifying datum uniquely identifying a second person;
receiving at least one second STD datum of the second person;
providing electronically the first identifying datum and the first STD datum to a requestor authorized by the first person; and
providing electronically the second identifying datum and the second STD datum to a further requestor authorized by the second person.

2. A computerized system for confidentially providing STD information comprising:
a server, a plurality of remote devices capable of communicating with the server, including a first remote device and a second remote device;
the server including a database comprising at least one first identifying datum uniquely identifying a first person; at least one first STD datum of the first person; at least one second identifying datum uniquely identifying a second person; at least one second STD datum of the second person; the server capable of, in response to an electronic request from the first remote device, providing electronically the first identifying datum and the first STD datum to a requestor authorized by the first person, and, in response to a further request from the second remote device, providing electronically the second identifying datum and the second STD datum to a further requestor authorized by the second person.

3. A method for operating an STD database comprising:
receiving at least one first identifying datum uniquely identifying a first person;
receiving at least one first STD datum of the first person;
receiving at least one second identifying datum uniquely identifying a second person;
receiving at least one second STD datum of the second person;
storing the data above in a database; and
allowing the first identifying datum and the first STD datum to be accessed remotely by a third person given a password by the first person, the first person remaining anonymous.
